(19) United States
(12) Patent Application Publication
(10) Pub. No.: US 2008/0153940 A1
(43) Pub. Date: Jun. 26, 2008

(54) BIODEGRADABLE COMPOSITIONS AND BIODEGRADABLE ARTICLES MADE THEREOF

(75) Inventors: Frederic Scheer, Hawthorne, CA (US); Shriram Bagrodia, Hawthorne, CA (US); Thomas F. Bash, Hawthorne, CA (US); William E. Kelly, Hawthorne, CA (US)

Correspondence Address: BELL, BOYD & LLOYD, LLP, P.O. Box 1135, CHICAGO, IL, 60690, US

(73) Assignee: CEREPLAST, INC., Hawthorne, CA (US)

(21) Appl. No.: 12/035,192

(22) Filed: Feb. 21, 2008

Related U.S. Application Data
(63) Continuation-in-part of application No. 11/953,547, filed on Dec. 10, 2007.
Application No. 11/953,547 is a continuation-in-part of application No. 11/365,579, filed on Feb. 28, 2006.

(51) Int. Cl. C08L 67/00

(52) U.S. Cl. 523/124

(57) ABSTRACT

Biodegradable compositions and methods of making the compositions are provided. In a general embodiment, the present disclosure provides a biodegradable composition made from starting material comprising poly(lactic acid), co-polyester polymer with adipic acid compounded and one or more additives such as plasticizers, flow promoters, polymer processing aids, slip agents, viscosity modifiers, chain extenders, spherical glass beads, organic fillers, inorganic fillers, fibers or combinations thereof. In addition, the present disclosure provides processes for making the biodegradable compositions as well as biodegradable articles made using the biodegradable compositions such as molded, formed and extruded articles.

### PRIORITY CLAIM

This Application is a continuation-in-part application of U.S. patent application Ser. No. 11/953,547 filed on Dec. 10, 2007, which is a continuation-in-part application of U.S. patent application Ser. No. 11/365,579 filed on Feb. 28, 2006, the entire contents of which are expressly incorporated herein by reference thereto.

### BACKGROUND

The present disclosure relates to polymer compositions. More specifically, the present disclosure relates to biodegradable compositions, methods for making and using the biodegradable compositions and biodegradable articles made from the biodegradable compositions.

Packaging material and disposable beakers, cups and cutlery are used widely nowadays and allow food material to be sold and/or consumed under hygienic conditions. Such disposable materials and objects are highly desired by consumers and retailers because they may be simply disposed of after use and do not have to be washed and cleaned like conventional dishes, glasses or cutlery.

Unfortunately, the widespread and growing use of such disposable materials results in a mounting amount of litter produced each day. Currently, the plastic waste is either provided to garbage incinerators or accumulates in refuse dumps. These methods of waste disposal cause many problems for the environment.

### SUMMARY

The present disclosure is directed to biodegradable polymer and nanopolymer compositions, methods for making and using the biodegradable compositions and biodegradable articles made from the biodegradable compositions. In a general embodiment, the present disclosure provides a biodegradable composition made from starting materials comprising between about 25% and about 45% by weight of poly(lactic acid) polymer (PLA) on the basis of the total weight of the biodegradable composition, between about 40% and about 70% by weight of a co-polyester polymer with adipic acid on the basis of the total weight of the polymer composition, and one or more additives such as plasticizers, flow promoters, polymer processing aids, slip agents, viscosity modifiers, chain extenders, spherical glass beads, organic fillers, inorganic fillers, fibers or combination thereof. A notched Izod-impact of the biodegradable composition at −40° C. is more than 0.5 ft-lb/in.

In an embodiment, a notched Izod-impact of the composition at −10° C. is more than 1.0 ft-lb/in.

In an embodiment, a notched Izod-impact of the composition at 10° C. is more than 2.0 ft-lb/in.

In an embodiment, a notched Izod-impact of the composition at 25° C. is more than 7.0 ft-lb/in.

In an embodiment, the composition is made from an additional starting material comprising nanoparticles of a mineral material such as silica, nanoclays of the vermiculite family, magnesium silicate or combination thereof

In an embodiment, the nanoparticles comprise between about 0.01% and about 6% by weight on the basis of the total weight of the biodegradable composition.

In an embodiment, the nanoparticles of the mineral material have a size ranging between about 20 and about 500 nanometers.

In an embodiment, the nanoparticles of the mineral material have a degree of purity of at least 99.9%.

In an embodiment, the biodegradable composition is made from an additional starting material comprising organic peroxide.

In an embodiment, the organic peroxide comprises between about 0.01% and about 5% by weight on the basis of the total weight of the biodegradable composition.

In an embodiment, the organic peroxide can be diacetyl peroxide, cumyl-hydroperoxide, dibenzoyl peroxide, dialkyl peroxide, 2,5-methyl-2,5-di(terbutylperoxy)-hexane or combination thereof.

In an embodiment, the biodegradable composition comprises between about 5% and about 35% of calcium sulfate.

In an embodiment, the biodegradable composition comprises organically coated calcium carbonate.

In an embodiment, the biodegradable composition comprises an oligomeric chain extender.

In an embodiment, the oligomeric chain extender is a styrene-acrylic copolymer, an oligomer containing glycidyl groups incorporated as side chains or combinations thereof.

In an embodiment, the biodegradable composition comprises between about 1% and about 32% of particles of a mineral filler such as magnesium silicate, talc or combination thereof. The mineral filler can have a particle size ranging between about 0.2 and about 4.0 microns.

In an embodiment, the co-polyester polymer can be a polyester, co-polyester or combination thereof.

In another embodiment, the present disclosure provides a molded, extruded or thermoformed article comprising a biodegradable composition made from starting materials comprising between about 25% and about 45% by weight of poly(lactic acid) polymer, between about 40% and about 70% by weight of co-polyester polymer with adipic acid, and at least one additive such as plasticizers, flow promoters, polymer processing aids, slip agents, viscosity modifiers, chain extenders, spherical glass beads, organic fillers, inorganic fillers, fibers and combinations thereof, each on the basis of the total weight of the biodegradable composition.

In an embodiment, the article can be utensils, food service-ware, forks, spoons, knives, chopsticks, containers, cups, plates, pots or combinations thereof.

In an alternative embodiment, the present disclosure provides a method of producing an article comprising a biodegradable composition. The method comprises (i) providing between about 25% and about 45% by weight of poly(lactic acid) polymer, between about 40% and about 70% by weight of co-polyester polymer with adipic acid, and at least one additive selected from the group consisting of plasticizers, flow promoters, polymer processing aids, slip agents, viscosity modifiers, chain extenders, spherical glass beads, organic fillers, inorganic fillers, fibers and combinations thereof, each on the basis of the total weight of the biodegradable composition, (ii) mixing the constituents of (i) so as to prevent the creation of aggregates, (iii) heating the mixture to a temperature ranging from about 95° C. to about 135° C., and (iv) forming the heated mixture to obtain a desired shape of the article.

In an embodiment, at least one of the additives is indirectly introduced into a barrel of a mixer/extruder.

In an embodiment, at least one of the additives is introduced into a barrel of a mixer/extruder through a side feeder.

In an embodiment, forming the heated mixture includes subjecting the biodegradable composition to a process selected from the group consisting of injection molding, profile extrusion, thermoform extrusion and combinations thereof.

An advantage of the present disclosure is to provide an improved biodegradable polymer composition.

Another advantage of the present disclosure is to provide a biodegradable polymer composition that exhibits improved mechanical performance.

Yet another advantage of the present disclosure is to provide a biodegradable polymer composition that exhibits improved thermal performance.

Still another advantage of the present disclosure is to provide an improved method of making a biodegradable polymer composition.

Additional features and advantages are described herein, and will be apparent from, the following Detailed Description.

### DETAILED DESCRIPTION

The present disclosure is directed to biodegradable polymer and nanopolymer compositions, methods for making and using the biodegradable compositions and biodegradable articles made from the biodegradable compositions. Biodegradation can refer to a degradation process resulting from the action of naturally occurring microorganisms such as bacteria, fungi and algae. For example, biodegradable polymers can be comprised of components that are reduced in film or fiber strength by microbial catalyzed degradation. The biodegradable polymers are reduced to monomers or short chains, which are then assimilated by the microbes. In an aerobic environment, these monomers or short chains are ultimately oxidized to CO₂, H₂O, and new cell biomass. In an anaerobic environment the monomers or short chains are ultimately oxidized to CO₂, H₂O, acetate, methane, and cell biomass.

Successful biodegradation requires direct physical contact between the biodegradable polymers and the active microbial population or the enzymes produced by the active microbial population. Moreover, certain minimal physical and chemical requirements such as suitable pH, temperature, oxygen concentration, proper nutrients, and moisture level should be met (cf. U.S. Pat. No. 6,020,393).

Generally, a degradable composition is designed to undergo a significant change in its chemical structure under specific environmental conditions, resulting in a loss of some properties that may be measured by standard tests methods appropriate to the plastic and the application in a period of time that determines its classification. Depending on the additional components present in the composition and the dimensions of the object made from the degradable material, the time period required for degradation will vary and may also be controlled when desired. The time span for biodegradation is usually significantly shorter than the time span required for a degradation of objects made from conventional plastic materials having the same dimensions, such as e.g. polyethylene, which have been designed to last for as long as possible. For example, cellulose and Kraft paper can biodegrade within 83 days in a compost environment.

Biodegradable compositions of the present disclosure can be biodegradable when exposed to specific environmental conditions such as composting, which will result in a loss of some properties that may be measured by standard methods appropriate to the plastic and in the application in a period of time that determines its classification. For instance, composting is a managed process that controls the biological decomposition and transformation of biodegradable materials into humus-like substance called compost: the aerobic mesophilic and thermophilic degradation of organic matter to make compost; the transformation of biologically decomposable material through a controlled process of biooxidation that proceed through mesophilic and thermophilic phases and results in the production of carbon dioxide, water, minerals, and stabilized organic matter (compost or humus) (ASTM Terminology). Consequently, main components of the biodegradable compositions of the present disclosure such as poly(lactic acid) and co-polyester polymer with adipic acid will be degraded to small organic fragments which will create stabilized organic matter and will not introduce any hazard or heavy metals into soil.

In an embodiment, the biodegradable compositions of the present disclosure biodegrade in a shorter period of time and will pass the tests required by ASTM 6400 D99, which demand that compostable plastic biodegrades within less than 180 days. Articles made from polyethylene do not degrade under normal composting conditions, and PLA-based articles take weeks to degrade in compost environments (about 6 to 8 weeks).

Articles made from the biodegradable compositions in embodiments of the present disclosure will not contribute to a further increase of refuse dumps; on the contrary, they will allow creation of organic fertilizers such as compost, while such objects simultaneously provide all advantages of disposable objects highly estimated by the consumers and producer. Articles made of the biodegradable compositions according to the present disclosure may be disposed after use, are essentially of lightweight, and do not need to be transported to a location where they have to be cleaned. In particular, articles made from a biodegradable compositions according to the present disclosure provide the advantage that articles thrown away in parks or at the beach will degrade and will vanish after some time. However, this disclosure should not be publicize as a license to litter the environment.

In a general embodiment, the biodegradable compositions are made from starting materials comprising between about 25% and about 45% by weight of poly(lactic acid) polymer (PLA) on the basis of the total weight of the biodegradable composition, between about 40% and about 70% by weight of a co-polyester polymer with adipic acid on the basis of the total weight of the biodegradable composition, and one or more additives such plasticizers, flow promoters, polymer processing aids, slip agents, viscosity modifiers, chain extenders, spherical glass beads, organic fillers, inorganic fillers, fibers or combination thereof.

The additives can be any suitable plasticizers, flow promoters, polymer processing aids, slip agents, viscosity modifiers, chain extenders, spherical glass beads, organic fillers, inorganic fillers and fibers known by the skilled artisan and can be added in any suitable amount. In an embodiment, each additive can be added in an amount ranging, for example, between 0.1% and 5% on the basis of the total weight of the biodegradable composition. Biodegradable compositions according to the present disclosure may be produced by completely or partially from renewable sources when desired. In addition, the biodegradable compositions according to the present disclosure may be adapted to various processing methods known in the art.

Poly(lactic acid) may be represented by the following structure:

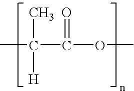

wherein n for example can be an integer between 10 and 250. Poly(lactic acid) can be prepared according to any method known in the state of the art. For example, poly(lactic acid) can be prepared from lactic acid and/or from one or more of D-lactide (i.e. a dilactone, or a cyclic dimer of D-lactic acid), L-lactide (i.e. a dilactone, or a cyclic dimer of L-lactic acid), meso D,L-lactide (i.e. a cyclic dimer of D- and L-lactic acid), and racemic D,L-lactide (racemic D,L-lactide comprises a 1/1 mixture of D- and L-lactide).

PLAs resemble clear polystyrene and have good gloss and clarity for aesthetic appeal, along with physical properties well suited for use as fibers, films, and thermoformed packaging. PLA is biocompatible and has been used extensively in medical and surgical applications, e.g. sutures and drug delivery devices. Unfortunately, PLA present major weaknesses such as brittleness as well as low thermal resistance, 136° F. (58° Celsius) and moisture-related degradation, limiting a lot of commercial applications.

It has been surprisingly found that the biodegradable compositions according to the present disclosure provide physical properties that are not inherent to poly(lactic acid) and provide significant improvements with respect to the processability, production costs or heat resistance along with improved flexibility and ductility without decreasing their biodegradability.

The combination of a blending step performed at ambient temperature (e.g. 18° C.-23° C.) followed by extrusion at relatively high temperature and pressure through e.g. a twin screw extruder provides, in part, the creation of brand new shapes, structures or morphologies of the polymer. In an embodiment, extrusion of a blended polymer mass compounded with selected additives and/or mineral nanoparticles at a high temperature induces shear forces that promote an exfoliation and dispersion of the components. As a result, the new polymer composition can be constructed by evenly dispersing the selected additives and/or mineral material into nanoparticles that form platelets.

In an embodiment, the dispersion of the platelets is important to make the compositions improved, and the inventor has especially worked on avoiding the creation of aggregate of platelets, which would prevent the improvement in the properties herein described. This can be been achieved according to the present disclosure by making use of a custom designed side feeder for mixing the mineral nanoparticles, e.g. a tower to enter the barrel of the extruder. Direct injection of the additives and/or nanoparticles to the molten polymer material can be avoided, which allows the necessary good and smooth distribution of the platelets during mixing and extrusion. As a result, these platelets are evenly distributed throughout the polymer matrix to create multiple parallel layers typical of the new polymer morphology discuss previously. To facilitate and to ensure a homogeneous dispersion of the platelets, the additives and/or nanoparticles can eventually be dispersed using a liquid such as, for example, soybean oil or glycerin as a matrix. In a high speed blender with a controlled environment, nanoclays can be blended with the liquid matrix in an amount up to 0.25% by weight of the overall composition.

In an embodiment, the physical and thermal properties of biodegradable compositions comprising nanoparticles are so altered as compared to standard polymer material that the inventor retains that there is creation of a brand new material to be called “biodegradable nanopolymer composition.” The new shape, structure or morphology that characterizes the biodegradable nanopolymer compositions of the disclosure tremendously and surprisingly improves the physical properties of the composition, namely its thermal properties and thermal stability (e.g., such compositions exhibit a significant improvement in terms of thermal resistance of the magnitude of 35 to 45° F. (about 1.7 to 7.2° C.) depending on specific formulations).

Because of their unique properties, the biodegradable polymer and nanopolymer compositions in embodiments of the present disclosure can be formed into biodegradable articles or items that can be degraded in a natural environment in a time period that is significantly shorter as compared to the time period required for the degradation of conventional plastic materials, such as e.g. polyethylene. In a controlled environment such as a composting site, the compositions can allow biodegradation in period of time not to exceed 180 days, one of the time requirements set by the US specification set by ASTM (ASTM 6400 D99). Moreover, the biodegradable nanopolymer compositions can made into various articles such as bags, bottles or cutlery exhibiting desired properties for the respective purpose.

In another embodiment, the biodegradable nanopolymer composition is made from starting materials comprising between about 25% by weight to 45% by weight of poly(lactic acid) polymer, between about 40% by weight to 70% by weight of co-polyester polymer with adipic acid, between about 0.01% and about 6% by weight of nanopartictes of a mineral material selected from the group consisting of silica, magnesium silicate and combinations thereof, and between about 0.01% and about 5% by weight of organic peroxide, each on the basis of the total weight of the biodegradable nanopolymer composition. The biodegradable nanopolymer composition can further comprise one or more additives such as plasticizers, flow promoters, polymer processing aids, slip agents, viscosity modifiers, chain extenders, spherical glass beads, organic fillers, inorganic fillers, fibers or combination thereof.

The incorporation of the nanoparticles or nano-sized fillers, whether they are minerals or organic fibers, creates the foundation of polymer nanocomposites. The benefits of nanocomposites extend well beyond one or two improvements but translate into several improvements of physical and thermal properties of polymers at such degree that the starting core polymer matrix composition is modified into new shapes or structures, which allow eventually the creation of completely novel material or features.

In an embodiment, the biodegradable compositions can be made by mixing or blending the respective constituents in the desired amounts. This may be performed according to any method known in by the skilled artisan. For example, poly(lactic acid) polymer and co-polyester polymer with adipic acid may be mixed in pure form, for example blended by means of mill roll blending, and heated to a temperature chosen according to the general knowledge in the art such that at least one of the above-mentioned components is partially or essentially completely molten.

The preparation of polyesters and copolyesters is well known in the art, such as disclosed in U.S. Pat. No. 2,012,267, which is incorporated herein by reference. Such reactions are typically operated at temperatures from 150° C. to 300° C. in the presence of polycondensation catalysts such as titanium isopropoxide, manganese diacetate, antimony oxide, dibutyl tin diacetate, zinc chloride, or combinations thereof. The catalysts are typically employed in amounts between 10 to 1000 parts per million (ppm), based on total weight of the reactants (cf. U.S. Pat. No. 6,020,393).

As previously discussed, in addition to the poly(lactic acid) and the copolyester of adipic acid, the composition can be compounded with nanoparticles of a mineral material having a particular particle size. For example, nanoparticles according to the disclosure comprise particles having a size definitely lower than the common size of current ground mineral equivalents that are usually of the order of several microns. According to an embodiment of the present disclosure, the nanoparticles have an average size ranging between about 20 and a maximum of 500 nanometers. In another embodiment, good performance can be achieved with a nanoparticle mineral having an average particle size ranging between about 200 to about 400 nanometers, e.g. about 250 nanometers.

Although particle size is an important parameter to achieve the desired performance, the extremely high degree of purity of the nanoparticle mineral selected can be significant. For example, the purity of the selected mineral material can have a degree of purity of at least 99.9% and preferably a degree of purity of at least 99.99% (e.g. pure silica or magnesium silicate). Special qualities of finely ground silica as provided by the specialized trade have proved suitable within the framework of the present disclosure.

The biodegradable polymers can further comprise between 1 and 32% by weight of additional mineral particles having specific particle sizes. Examples of such minerals are montmorillonite or talc. The minerals acting as filler add strength and impart stiffness. In an embodiment, the mineral particles have a size of 0.2 to 4.0 microns. In another embodiment, the mineral particles have a size of 1 to 2 microns.

During the preparation of biodegradable compositions according to the present disclosure, organic peroxide may be added to the reaction mixture in an amount between about 0.01% and about 5% by weight, on the basis of the total weight of the biodegradable final polymer composition. Examples of organic peroxides that may be used for preparing a composition according to the present disclosure are e.g. diacetyl peroxide, cumyl-hydroperoxide, and dibenzoyl peroxide. Other organic peroxides known to a skilled person may be used as well. The organic peroxides serve as radical starter molecules initiating a polymerization and help to provide connections, in particular covalent bonds, between the components present in a composition according to the present disclosure.

In another embodiment, the biodegradable compositions can comprise a calcium sulfate. For example, the addition of calcium sulfate to the formulations increases the heat deflection temperature. A preferred calcium sulfate is commercially sold as US GYPSUM® calcium sulfate. In an alternative embodiment, the biodegradable compositions can comprise an organically coated calcium carbonate. It has been surprisingly discovered that adding organically coated calcium carbonate (e.g. commercially available as EMforce® Bio) to formulations of PLA and copolyester polymers with adipic acid (e.g. ECOFLEX® from BASF) improves their impact properties substantially.

The EMforce® Bio organically coated calcium carbonate is supplied by Specialty Minerals, Inc. It is high aspect ratio calcium carbonate that has elongated morphology. It is characterized by a major axis of 1.08 microns, a minor axis of 0.25 microns and an average aspect ratio of 5.4 with the organic coating. The organically coated calcium carbonate enhances the crystallization behavior of PLA both from the melt and the glass state.

In still another embodiment, the addition of oligomeric chain extenders to the biodegradable compositions has also been found to be particularly useful for extrusion coating applications. For example, a preferred oligomeric chain extender comprises styrene-acrylic copolymers or oligomers containing glycidyl groups incorporated as side chains. Several useful examples are described in the International Patent Application WO 03/066704 A1 assigned to Johnson Polymer, LLC, which incorporated herein by reference. These materials are based on oligomers with styrene and acrylate building blocks that have desirable glycidyl groups incorporated as side chains. A high number of epoxy groups per oligomer chain is desired, at least about 10, preferably greater than about 15, and more preferably greater than about 20. These polymeric materials generally have a molecular weight greater than about 3000, preferably greater than about 4000, and more preferably greater than about 6000. These are commercially available from Johnson Polymer, LLC under the JONCRYL® trade name such as JONCRYL® ADR 4368. Another additive from Arkema Inc, Biostrength™ 700 can also enhance melt strength of the materials of the present disclosure. Biostrenth™ 700 is an acrylic based copolymer.

These agents can provide significant branching into the biodegradable composition. These agents are not monomers in the biodegradable composition synthesis but rather link one end of a biodegradable polymeric composition strand to an end of a second biodegradable composition strand. The process of accomplishing this result can be through the reaction of an already synthesized biodegradable polymeric composition, for example, in a melt with the noted agent. Catalysts can be employed if needed and/or desired. The reaction can occur in any convenient reactor or an extruder during the compounding of the biodegradable nanopolymer composition.

Depending on the specific applications desired, the biodegradable composition of the present disclosure may also comprise additional additives or components well known in the art, namely biodegradable components or additives such as e.g. natural coloring agents and/or additional polymeric compounds like starch, processed starch, cellulose, cellulose fibers, proteins, protein fibers, etc. The starch can be made from any suitable source such as corn, tapioca, maize, wheat, rice or combination thereof. The starch can be in any suitable form such as, for example, a powder.

In alternative embodiments, the biodegradable compositions of the present disclosure can comprise formulations that are modified with any suitable amount of plasticizers, flow promoters, polymer processing aids, slip agents, viscosity modifiers, chain extenders, spherical glass beads, organic fillers, inorganic fillers, fibers and the like.

The plasticizers can be, for example, any suitable material that softens and/or adds flexibility to the materials they are added to. The plasticizers can soften the final product increasing its flexibility. Suitable plasticizers include, for example, polyethylene glycol, sorbitol, glycerine, soybean oil, caster oil, TWEEN 20, TWEEN 40, TWEEN 60, TWEEN 80, TWEEN 85, sorbitan monolaurate, sorbitan monooleate, sorbitan monopalmitate, sorbitan trioleate, sorbitan monostearate, PEG, derivatives of PEG, N,N-ethylene bis-stearamide, N,N-ethylene bis-oleamide, polymeric plasticizers such as poly(1,6-hexamethylene adipate) or combination thereof.

Examples of organic fillers include wood flour, seeds, polymeric particles, ungelatinized starch granules, cork, gelatins, wood flour, saw dust, milled polymeric materials, agar-based materials, and the like. Examples of inorganic fillers include calcium carbonate, titanium dioxide, silica, talc, mica, sand, gravel, crushed rock, bauxite, granite, limestone, sandstone, glass beads, aerogels, xerogels, clay, alumina, kaolin, microspheres, hollow glass spheres, porous ceramic spheres, gypsum dihydrate, insoluble salts, magnesium carbonate, calcium hydroxide, calcium aluminate, magnesium carbonate, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, and the like. A wide variety of other inorganic fillers may be added as starting materials to the biodegradable compositions including, for example, metals and metal alloys (e.g., stainless steel, iron, and copper), balls or hollow spherical materials (such as glass, polymers, and metals), filings, pellets, flakes and powders (such as microsilica).

Examples of fibers that may be incorporated into the biodegradable compositions include naturally occurring organic fibers, such as cellulosic fibers extracted from wood, plant leaves, and plant stems. These organic fibers can be derived from cotton, wood fibers (both hardwood or softwood fibers, examples of which include southern hardwood and southern pine), flax, abaca, sisal, ramie, hemp, and bagasse. In addition, inorganic fibers made from glass, graphite, silica, ceramic, rock wool, or metal materials may also be used.

The biodegradable compositions of the present disclosure may be used for the production of various articles, such as e.g. molded articles and/or extruded articles. The term “molded article” (or “extruded article”) as used in the present disclosure comprises articles made according to a molding process (or an extrusion process). A “molded article” (or “extruded article”) can also be part of another object, such as e.g. an insert in a container or a knife blade or fork insert in a corresponding handle. Injection molding, profile extrusion and thermoform extrusion are processes known to a skilled person and are described for example in Modern Plastics Encyclopedia, Published by McGraw-Hill, Inc. mid-October 1991 edition.

An extruded or molded article according to the present disclosure comprises a biodegradable composition made from starting materials comprising between about 25% and about 45% by weight of poly(lactic acid) polymer, between about 40% and about 70% by weight of co-polyester polymer with adipic acid, and at least one additive such as plasticizers, flow promoters, polymer processing aids, slip agents, viscosity modifiers, chain extenders, spherical glass beads, organic fillers, inorganic fillers, fibers and combinations thereof, each on the basis of the total weight of the biodegradable composition. The biodegradable composition can further comprise between about 0.01% and about 6% by weight of nanoparticles of a mineral material selected from the group consisting of silica, magnesium silicate and combinations thereof, and between about 0.01% and about 5% by weight of organic peroxide, each on the basis of the total weight of the biodegradable composition. In an embodiment, the nanoparticles of a mineral material comprise about 4% of at least 99.9%, preferably 99.99% pure finely ground silica.

Examples of various molded article are utensils, forks, spoons, knives, chopsticks, containers and cups. Extruded articles can be films, trash bags, grocery bags, container sealing films, pipes, drinking straws, spun-bonded non-woven materials, and sheets. Articles according to the present disclosure can be made from a profile extrusion formulation (e.g. drinking straws and pipes). Articles according to the present disclosure can also made from a thermoform extrusion method (e.g. sheets for producing cups, plates and other objects that could be outside of the food service industry). As outlined in detail before, the compositions for the preparation of such molded/extruded articles can comprise mono ester(s), and/or natural plasticizer(s) in addition to the above-mentioned components.

By way of example and not limitation, the following examples are illustrative of various embodiments of the present disclosure. The formulations below are provided for exemplification only, and they can be modified by the skilled artisan to the necessary extent, depending on the special features that are looked for.

### EXAMPLE 1

### Injection Molding Formulations (General)

Several injection molding formulations have been using the following ingredients in proportions varying within the ranges provided here below:

from 75% to 91% by weight poly(lactic acid) polymer

from 2% to 5% by weight (co-polyester polymer with adipic acid)

from 0.2% to 4% by weight of finely ground 99.99% pure silica**

From 0.01 to 4% organic peroxide, diacetyl peroxide

(** average size particle of about 250 nanometers)

It is important that introducing the mineral nanoparticles be performed without creating aggregates, using for instance a side-feeder that would not inject the nanoparticles directly into the barrel of the extruder but through a tower letting the nanoparticles fall and mix smoothly with the molten material.

The above-mentioned compounds are mixed by means of extrusion compounding at a temperature not to exceed 160° C. over a period ranging from 25 sec to 2 min. Then, the resulting mixture is filled in an injection molding device at a temperature of about 160° C. and is injected into a mold at a temperature of about 20° C. in order to obtain an injection molded cup.

### EXAMPLE 2

### Injection Molding Formulation (Specific)

An injection molding formulation is prepared that comprises:

74.5% by weight poly (lactic acid) polymer

5% by weight (co-polyester polymer with adipic acid)

15% by weight of magnesium silicate (talc)

5% by weight of finely ground 99.99% pure silica**, and

0.5% by weight of 2,5-Dimethyl-2,5-di(t-butyl peroxy) hexane

(** average size particle of about 250 nanometers)

The injection molding formulation is prepared as detailed in Example 1 and injection molded products may be obtained according to the steps lined out in said Example 1.

### EXAMPLE 3

### Profile Extrusion Formulation

Several profile extrusion formulations have been using the following ingredients in proportions varying within the ranges provided here below:

from 65% to 75% by weight poly lactic acid polymer

from 15% to 20% by weight of co-polyester polymer with adipic acid

from 1% to 5% by weight finely ground 9.99% pure silica**

From 0.5% to 2% by weight of 2,5-Dimethyl-2,5-di(t-butyl peroxy) hexane

(**average size particle of about 250 nanometers)

The above-mentioned compounds are mixed by twin screw compounding. The resulting mixture is filled in a profile extrusion device at a temperature not to exceed 160 ° C. and a tube is obtained which may be used as a drinking straw.

### EXAMPLE 4

### Thermoform Extrusion Formulation

Several thermo form extrusion formulations have been using the following ingredients in proportions varying within the ranges provided here below:

from 55% to 75% by weight poly lactic acid polymer

from 5% to 15% by weight of co-polyester polymer with adipic acid

from 4% to 9% by weight of magnesium silicate (talc)

from 1% to 5% by weight finely ground 99.99% pure silica**

from 0.2% to 1% by weight of 2,5-Dimethyl-2,5-di(t-butyl peroxy) hexane

(**average size particle of about 250 nanometers)

The above-mentioned compounds are mixed by twin screw compounding. The resulting mixture is filled in a thermoform extrusion device at a temperature not to exceed 160 ° C. and a sheet having a thickness between 0.1 mm to 45 mm is obtained which may be used for forming cups, plates or bottles.

### EXAMPLE 5

The following blend composition was prepared in a twin crew extruder and at temperatures not exceeding 160° C. The product was tested for heat deflection temperature (HDT) (at 66 psi per ASTM test method D648) and Vicat softening temperature (by ASTM D1525-07 test method).

PLA: 75%

3% Co-polyester polymer with adipic acid

CaSO₄: 22%

HDT @66 psi: 86.1 C

Vicat softening point: 124.7 C

### Control Sample:

PLA: 75%

3% copolyester polymer with adipic acid

Magnesium silicate (Talc): 22%

HDT @66 psi: 52.3

Vicat softening point: 62.1° C.

It was surprisingly found that addition of calcium sulfate would improve the HDT and Vicat softening point of these novel fonnulations. This is also observed in formulations that do not contain the nanoparticles and the organic peroxide additive. It is anticipated that this will also be the case when the nanoparticle additive and organic peroxide is present.

### EXAMPLE 6

### Biodegradable Nanopolymer Composition:

PLA: 78%

Adipic acid based copolyester 5%

Magnesium silicate 5%

Organically coated calcium carbonate 12% (EM force Bio grade from Specialty Minerals)

When compounded in a twin screw extruder and tested for impact strength, the biodegradable nanopolymer composition was found to have at least twice the impact strength of a corresponding formulation (with 17% magnesium silicate) without the addition of the organically coated calcium carbonate.

### EXAMPLE 7

### Biodegradable Nanopolymer Composition:

PLA: 84%

Caprolactone: 15%

Oligomeric chain extender (JONCRYL® Conc*): 0.75%

Polymer processing aid (STEPHAN® 2000 DS): 0.25%

(*JONCRYL® ADR-4368/CAPA® 6800 30%/70% from BASF)

The above composition was blended in a twin screw extruder at 170° F. and pelletized. The compounded resin was successfully used in extrusion coating process on paper products.

### Control Sample

PLA: 84%

Caprolactone: 15%

Polymer processing aid (STEPHAN® 2000 DS): 0.25%

The control compounded resin failed to perform in the extrusion coating process on paper products (e.g. it has a very low viscosity).

### EXAMPLE 8

PLA: 84%

Copolyester with adipic acid: 15%

Oligomeric chain extender (Arkema Biostrength™ 700 or JONCRYL® Conc*): 0.75%

Polymer processing aid (STEPHAN® 2000 DS): 0.25%

(*JONCRYL® ADR-4368/CAPA® 6800 30%/70% from BASF)

The product performed well in extrusion coating applications (e.g. it has a higher viscosity than the control example in Example 7).

### EXAMPLE 9

A blend was made of the following materials: PLA 4042D (poly(lactic acid)) from Nature Works (35.5%), ECOFLEX® FBX 7011 (co-polyester polymer with adipic acid) from BASF (55%), 110 P8 Spericel™ Hollow Sphere (processing aid) from Potter Industries (3%), HALLSTAR® PEG 6000DS (plasticizer) from Hallstar (2%), and CRODAMIDE® ER (slip agent) from Cooda Inc. (0.5%). The mixture was blended at room temperature in a low shear mixer and fed to a 75 mm twin screw extruder.

HALLGREEN® RX-14010 (plasticizer) from Hallstar (4%) was fed into the side feeder of the 75 mm twin screw extruder. All percentages are based on the final product.

The extruder was run at 330 rpm and a temperature profile of 130° C. was maintained. The extruded strand was quenched in a water bath and strand cut into pellets.

The pellets were dried at 140° C. for 6 hours and injection molded into test specimens for tensile, flexural, and notched izod impact properties per respective ASTM test standards (tensiles (ASTM D-638), flexural modulus (ASTM D-790) and Notched-Izod Impact (ASTM D-256). Notched-Izod impact tests were run at 25° C., 10° C., −10° C., and −40° C. Low temperature brittleness was measured by ASTM test method D746. The results are shown in the tables below.

TABLE 1
Tensile and Flexural Test Results at

| | | | Flexural Test | | | | |
|---|---|---|---|---|---|---|---|
| Tensile Test | | | | | | Elong. | |
| | Elong | | | Elong. | | @ | |
| Stress | @ | E- | Yield | ® | Max. | Max. | |
| @break | break | Modulus | Stress | yield | Stress | Stress | E-Mod |
| kpsi | % | MPa | kpsi | % | kpsi | % | MPa |
| 2.38 | 284.17 | 693.23 | 0.91 | 1.62 | 1.36 | 4.09 | 382.95 |

TABLE 2
Izod Impact at Various Temperatures
Izod Impact (Notched)

| T (° C.) | (ft-lb/in) |
|---|---|
| 25 | 7.96 |
| 10 | 2.52 |
| −10 | 1.32 |
| −40 | 0.64 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A composition made from starting materials comprising:
between about 25% and about 45% by weight of poly(lactic acid) polymer (PLA) on the basis of the total weight of the composition;
between about 40% and about 70% by weight of a co-polyester polymer with adipic acid on the basis of the total weight of the composition; and
at least one additive selected from the group consisting of plasticizers, flow promoters, polymer processing aids, slip agents, viscosity modifiers, chain extenders, spherical glass beads, organic fillers, inorganic fillers, fibers and combinations thereof, wherein a notched Izod-impact of the composition at −40° C. is more than 0.5 ft-lb/in.

2. The composition of claim 1, wherein a notched Izod-impact of the composition at −10° C. is more than 1.0 ft-lb/in.

3. The composition of claim 1, wherein a notched Izod-impact of the composition at 10° C. is more than 2.0 ft-lb/in.

4. The composition of claim 1, wherein a notched Izod-impact of the composition at 25° C. is more than 7.0 ft-lb/in.

5. The composition of claim 1 made from an additional starting material comprising nanoparticles of a mineral material selected from the group consisting of silica, nanoclays of the vermiculite family, magnesium silicate and combinations thereof

6. The composition of claim 1, wherein the nanoparticles comprise between about 0.01% and about 6% by weight on the basis of the total weight of the composition.

7. The composition of claim 6, wherein the nanoparticles of the mineral material have a size ranging between about 20 and about 500 nanometers.

8. The composition of claim 6, wherein the nanoparticles of the mineral material have a degree of purity of at least 99.9%.

9. The composition of claim 1 made from an additional starting material comprising organic peroxide.

10. The composition of claim 9, wherein the organic peroxide comprises between about 0.01% and about 5% by weight on the basis of the total weight of the composition.

11. The composition of claim 9, wherein the organic peroxide is selected from the group consisting of diacetyl peroxide, cumyl-hydro-peroxide, dibenzoyl peroxide, dialkyl peroxide, 2,5-methyl-2,5-di(terbutylperoxy)-hexane and combinations thereof.

12. The composition of claim 1 comprising between about 5% and about 35% of calcium sulfate.

13. The composition of claim 1 comprising organically coated calcium carbonate.

14. The composition of claim 1 comprising an oligomeric chain extender.

15. The composition of claim 14, wherein the oligomeric chain extender is selected from the group consisting of styrene-acrylic copolymers, oligomers containing glycidyl groups incorporated as side chains and combinations thereof.

16. The composition of claim 1 comprising between about 1% and about 32% of particles of a mineral filler selected from the group consisting of magnesium silicate, talc and combinations thereof, the mineral filler having a particle size ranging between about 0.2 and about 4.0 microns.

17. The composition of claim 1, wherein the co-polyester polymer is selected from the group consisting of polyester, co-polyester and combinations thereof.

18. A molded, extruded or thermoformed article comprising:
a biodegradable composition made from starting materials comprising between about 25% and about 45% by weight of poly(lactic acid) polymer, between about 40% and about 70% by weight of co-polyester polymer with adipic acid, and at least one additive selected from the group consisting of plasticizers, flow promoters, polymer processing aids, slip agents, viscosity modifiers, chain extenders, spherical glass beads, organic fillers, inorganic fillers, fibers and combinations thereof, each on the basis of the total weight of the biodegradable composition, wherein a notched Izod-impact of the composition at −40° C. is more than 0.5 ft-lb/in.

19. The article of claim 18 made from an additional starting material comprising nanoparticles of a mineral material selected from the group consisting of silica, nanoclays of the vermiculite family, magnesium silicate and combinations thereof

20. The article of claim 18 made from an additional starting material comprising organic peroxide.

21. The article of claim 18, wherein the article is selected from the group consisting of utensils, food service-ware, forks, spoons, knives, chopsticks, containers, cups, plates, pots and combinations thereof.

22. A method of producing an article comprising a biodegradable composition, the method comprising:
(i) providing between about 25% and about 45% by weight of poly(lactic acid) polymer, between about 40% and about 70% by weight of co-polyester polymer with adipic acid, and at least one additive selected from the group consisting of plasticizers, flow promoters, polymer processing aids, slip agents, viscosity modifiers, chain extenders, spherical glass beads, organic fillers, inorganic fillers, fibers and combinations thereof, each on the basis of the total weight of the biodegradable composition;
(ii) mixing the constituents of (i) so as to prevent the creation of aggregates;
(iii) heating the mixture to a temperature ranging from about 95° C. to about 135° C.; and
(iv) forming the heated mixture to obtain a desired shape of the article, wherein a notched Izod-impact of the article at −40° C. is more than 0.5 ft-lb/in.

23. The method of claim 22, wherein at least one of the additives is indirectly introduced into a barrel of a mixer/extruder.

24. The method of claim 22, wherein at least one of the additives is introduced into a barrel of a mixer/extruder through a side feeder.

25. The method of claim 22, wherein forming the heated mixture includes subjecting the biodegradable composition to a process selected from the group consisting of injection molding, profile extrusion, thermoform extrusion and combinations thereof.
